(19) United States
(12) Patent Application Publication
(10) Pub. No.: US 2021/0266969 A1
(43) Pub. Date: Aug. 26, 2021

(54) RANDOM DETECTION THRESHOLD

(71) Applicant: QUALCOMM Incorporated, San Diego, CA (US)

(72) Inventors: Maarten Menzo WENTINK, Nijmegen (NL); Aleksandar DAMNJANOVIC, Del Mar, CA (US); Marco PAPALEO, Bologna (IT)

(21) Appl. No.: 17/146,153

(22) Filed: Jan. 11, 2021

Related U.S. Application Data
(60) Provisional application No. 63/011,126, filed on Apr. 16, 2020.
(60) Provisional application No. 62/979,394, filed on Feb. 20, 2020.

(51) Int. Cl. H04W 74/08; H04W 74/00; H04W 80/02

(52) U.S. Cl. CPC H04W 74/0825; H04W 80/02; H04W 74/008

(57) ABSTRACT

This disclosure provides wireless nodes, methods, apparatus, means plus and computer-readable mediums for randomly determining detection thresholds, such as energy detection (ED) thresholds, and then using such randomly determined thresholds to determine whether a channel is busy or idle when performing clear channel access (CCA). In some implementations, a new random detection threshold may be determined at a start of each backoff or each subsequent backoff slot. In some other implementations, a range of energy from which the detection threshold is randomly determined may depend on measurements of traffic activity, the number of MAC addresses observed or the priority of the traffic.

### CROSS REFERENCE TO RELATED APPLICATION

This Application hereby claims priority under 35 U.S.C. § 119 to pending U.S. Provisional Patent Application No. 62/979,394, filed on Feb. 20, 2020 and U.S. Provisional Patent Application No. 63/011,126, filed on Apr. 16, 2020, the contents of both are incorporated herein in their entirety.

### TECHNICAL FIELD

Certain aspects of the present disclosure generally relate to wireless communications and, more particularly, to techniques for randomizing channel access energy detection (ED) thresholds.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (such as tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly.

Certain aspects provide a method for wireless communications by a node. The method generally includes randomly determining, within a range of energy, a detection threshold for assessing if a wireless medium is busy or idle and performing clear channel assessment (CCA) of the wireless medium according to the randomly determined detection threshold.

Certain aspects provide an apparatus for wireless communications by a node. The apparatus generally includes means for randomly determining, within a range of energy, a detection threshold for assessing if a wireless medium is busy or idle and means for performing clear channel assessment (CCA) of the wireless medium according to the randomly determined detection threshold.

Certain aspects provide an apparatus for wireless communications by a node. The apparatus generally includes a processing system that randomly determines, within a range of energy, a detection threshold for assessing if a wireless medium is busy or idle and performs clear channel assessment (CCA) of the wireless medium according to the randomly determined detection threshold.

Certain aspects provide a wireless node that generally includes at least one antenna and a processing system that randomly determines, within a range of energy, a detection threshold for assessing if a wireless medium is busy or idle and performs, via the at least one antenna, clear channel assessment (CCA) of the wireless medium according to the randomly determined detection threshold

Certain aspects provide a computer-readable medium for wireless communications. The computer-readable medium generally includes codes executable to randomly determine, within a range of energy, a detection threshold for assessing if a wireless medium is busy or idle and perform clear channel assessment (CCA) of the wireless medium according to the randomly determined detection threshold.

Aspects of the present disclosure provide wireless nodes, means for, apparatuses, processors, and computer-readable mediums for performing the methods described herein. Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating an example exposed node scenario.

FIG. 4 is a diagram illustrating example channel access delays for an exposed node scenario.

FIG. 5 illustrates example operations for wireless communication, in accordance with certain aspects of the present disclosure.

FIG. 6 is a diagram illustrating example channel access delays for an exposed node scenario with backoff window synchronization, in accordance with certain aspects of the present disclosure.

FIG. 7 illustrates an example communications device that may include various components configured to perform operations for the techniques disclosed herein, in accordance with aspects of the present disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

An exposed node is a node such as a Node B that is located between two nodes (i.e., Node A and Node C) that are unable to hear each other. Hence, a transmission by Node A does not cause a backoff to be initiated by Node C, and vice versa. If Node C were to detect a particular amount of energy on the medium due to the transmission by Node A, Node C would perform a backoff for a period of time by temporarily waiting to access the medium after the medium transitions from busy to idle. As a result, the exposed Node B may observe a busy medium for long periods of time when each of the adjacent Nodes A and C transmit independently (and without synchronization), causing the exposed Node B to experience excessive backoffs or access delays.

Various implementations or aspects generally relate to wireless nodes that are operable in, at least, unlicensed spectrum. The described techniques uses one or more random detection thresholds (such as energy detection threshold, signal detection threshold or both) to help ensure that exposed nodes will more often declare a wireless medium as idle once they start contending and, therefore, will have more of an equal opportunity to access the wireless medium. New random detection thresholds may be determined at different times. In addition, various parameters for randomizing detection thresholds may be determined in various ways.

Particular implementations of the subject matter described in this disclosure can be implemented to realize one or more of the following potential advantages. In some implementations, the described techniques can be used to avoid a node being ‘stuck’ between other nodes when a new random detection threshold is determined at the start of each backoff or each subsequent backoff slot. In some other implementations, the impact of the exposed node problem on access delay times is alleviated when a range of energy from which the detection threshold is randomly determined depends on measurements of traffic activity, the number of MAC addresses observed or the priority of the traffic.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The acronyms listed below may be used herein, consistent with commonly recognized usages in the field of wireless communications. Other acronyms may also be used herein, and if not defined in the list below, are defined where first appearing herein.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may include an access point or an access terminal.

An access point (“AP”) may include, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ES S”), Radio Base Station (“RBS”), or some other terminology.

An access terminal (“AT”) may include, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may include a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communication device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communication link.

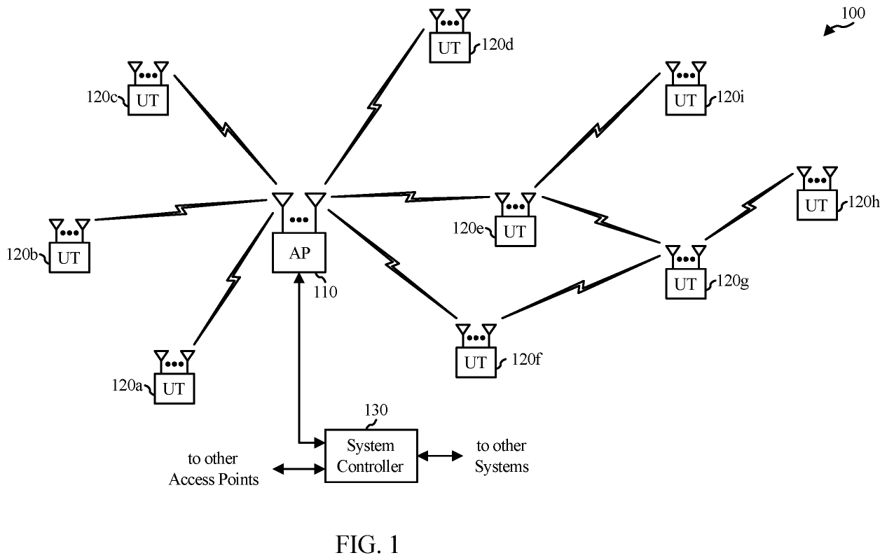

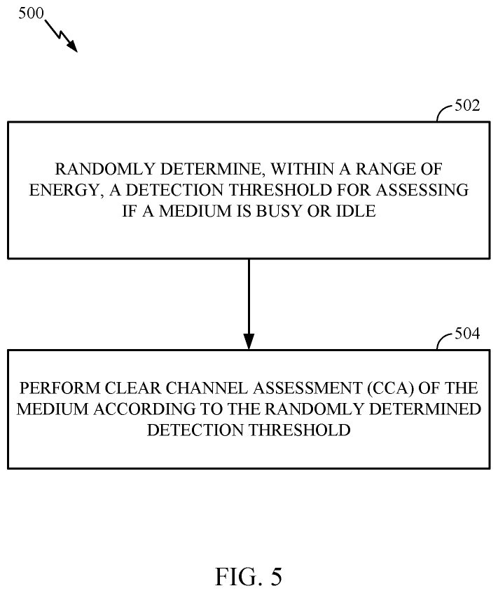

FIG. 1 illustrates a multiple-access multiple-input multiple-output (MIMO) system 100 in which aspects of the present disclosure may be practiced. For example, one or more access points 110 or user terminals 120 may be configured to perform clear channel access (CCA) with synchronized backoff windows in accordance with operations 500 of FIG. 5.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer or future user terminals being implemented with technology such as SDMA, OFDM or OFDMA to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to or receives user-specific data from the access point. In general, each selected user terminal may be equipped with one or multiple antennas (i.e., Nᵤₜ≥1). The K selected user terminals can have the same or different number of antennas.

The SDMA system may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (such as in order to keep costs down) or multiple antennas (such as where the additional cost can be supported). The system 100 may also be a TDMA system if the user terminals 120 share the same frequency channel by dividing transmission/reception into different time slots, each time slot being assigned to different user terminal 120.

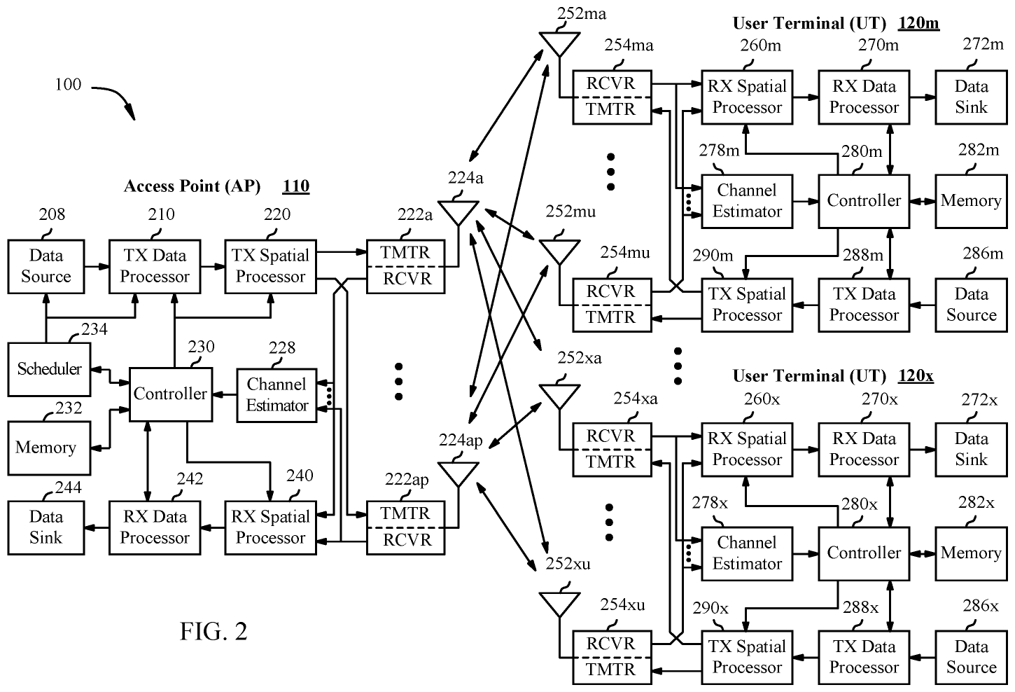

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut, x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. TX data processor 288 processes (such as encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut, m}, transmit symbol streams for the N_{ut, m}, antennas. Each transmitter unit (TMTR) 254 receives and processes (such as converts to analog, amplifies, filters, and frequency upconverts) a respective transmit symbol stream to generate an uplink signal. N_{ut,m}, transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (such as demodulates, deinterleaves, and decodes) each recovered uplink data symbol stream in accordance with the rate used for that stream to obtain decoded data. The decoded data for each user terminal may be provided to a data sink 244 for storage or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (such as encodes, interleaves, and modulates) the traffic data for each user terminal based on the rate selected for that user terminal. TX data processor 210 provides N_{dn} downlink data symbol streams for the Nan user terminals. A TX spatial processor 220 performs spatial processing (such as a precoding or beamforming, as described in the present disclosure) on the Nan downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120 (such as UT 120m), N_{ut,m} antennas 252ma through 252mu receive the Nₐₚ downlink signals from access point 110. Each receiver unit (such as receiver unit 254ma) processes a received signal from an associated antenna (such as antenna 252ma) and provides a received symbol stream. An RX spatial processor 260m performs receiver spatial processing on N_{ut,m} received symbol streams from N_{ut,m} receiver units 254ma through 254mu and provides a recovered downlink data symbol stream for the user terminal. The receiver spatial processing is performed in accordance with the CCMI, MMSE or some other technique. An RX data processor 270m processes (such as demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (such as the downlink or uplink eigenvectors, eigenvalues, SNR estimates, and so on) to the access point. Controllers 230 and 280 also control the operation of various processing units at access point 110 and user terminal 120, respectively.

Distributed channel access (DCA) in unlicensed spectrum is currently based on listen before talk (LBT) with a random backoff time. The general principle is for a transmitting device to first sense a channel (wireless medium) before transmitting. If the device does not sense energy above an energy detection (ED) threshold, the device declares the medium idle and is allowed to transmit. On the other hand, if the device senses energy on the medium above the ED threshold (indicating another device is transmitting), the device declares the medium busy and waits a random backoff time before trying to access the medium again. In similar fashion, a device may declare the medium busy when a preamble was detected above a preamble detection (PD) threshold and declare the medium idle when no preamble was detected above the PD threshold. ED threshold and PD threshold may be used intermittently in this disclosure, or be collectively referred to as CCA threshold.

As noted above, a node declares the medium to be busy or idle when the received amount of energy is above or a below a defined detection threshold, respectively (possibly in combination with a signal detect, for example, for a packet/frame preamble). For example, for the 5 GHz band in Europe, the energy detect threshold can be −72 dBm or a combination of −62 dBm energy detect and −82 dBm preamble detect.

The random backoff time is designed to help ensure distributed random arbitration between nodes in the same coverage area. In some cases, this LBT with random backoff time may have issues. For example, in some cases, a node may reside within the coverage area of two nodes that are not within their respective detection areas. Such a node is referred to as an exposed node. An exposed node may observe a busy medium from each or both of the adjacent nodes for long periods of time, causing the exposed node to experience excessive access delays.

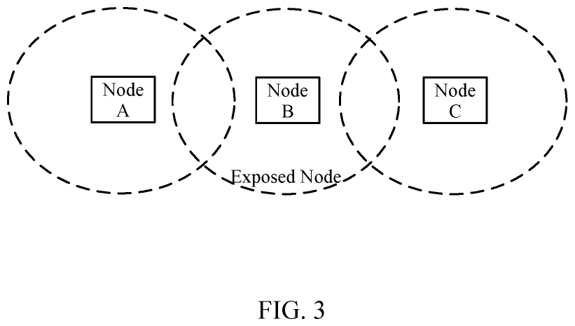

FIG. 3 illustrates an example of an exposed node scenario. As illustrated, the exposed node (Node B) is located between two nodes, Node A and Node C. Nodes A and C are unable to hear each other and, hence, a transmission by Node A does not cause a backoff to be initiated by Node C and vice versa. If Node C were to detect a particular amount of energy on the medium due to the transmission by Node A, Node C would perform a backoff for a period of time by temporarily waiting to access the medium after the medium transitions from busy to idle. As a result, exposed Node B may observe a busy medium for long periods of time when each of the adjacent Nodes A and C transmits independently (and without synchronization), causing the exposed Node B to experience excessive backoffs or access delays.

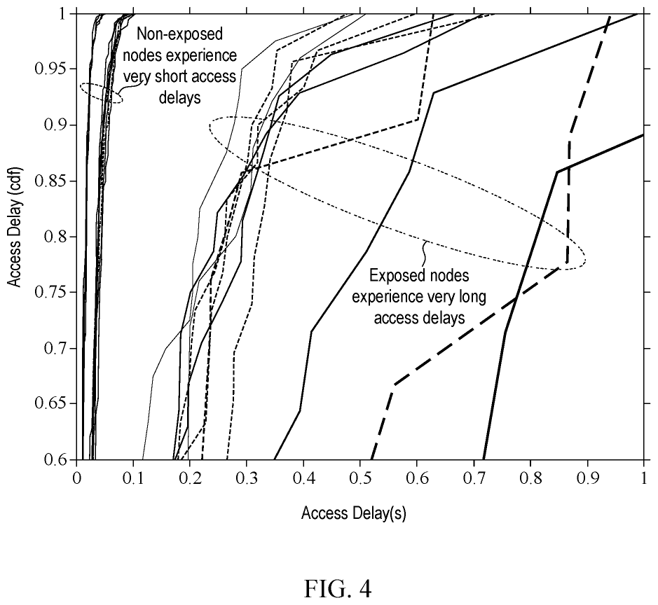

FIG. 4 illustrates the impact of the exposed node problem on access delay times. The example assumes a grid of 5×5 APs, with 3 STAs per AP randomly distributed in the coverage range of each AP. As illustrated, exposed nodes may experience much longer access delays relative to non-exposed nodes. In the example, 95% of the time, non-exposed nodes are able to access the medium in less than 0.05 s, while exposed nodes often experience access delay times of 0.2 s or higher.

Aspects of the present disclosure may help address the exposed node issue by providing randomized detection thresholds (such as energy detection or signal detection thresholds). Using randomized energy detection thresholds as described herein may help ensure that exposed nodes will more often declare a medium an idle medium once they start contending and, therefore, will have more of an equal opportunity to access the medium. Randomized energy detection thresholds may be used in conjunction with (conventional or synchronized) random backoff timers.

FIG. 5 is a flow diagram illustrating example operations 500 for wireless communication by a node, in accordance with certain aspects of the present disclosure. The operations 500 may be performed by an apparatus, such as the AP 110 (or UT 120).

Operations 500 begin, at 502, by randomly determining, within a range of energy, a detection threshold for assessing if a medium is busy or idle.

At 504, the node performing clear channel assessment (CCA) of the medium according to the randomly determined energy detection threshold.

The exposed node issue may be reduced when the detection threshold is determined randomly by the nodes, rather than being fixed. An exemplary range of energy could be between −82 dBm and −62 dBm, from which the detection threshold is selected uniformly randomly. At 20 dBm transmit power and assuming IEEE channel mode A, the exemplary detection threshold range of energy would correspond to a physical detection range of roughly between 20 m and 80 m, albeit not entirely linear over this range.

A random detection threshold can help address the exposed node issue because the adjacent nodes (nodes A and C in FIG. 3) will sometimes defer more (when smaller thresholds are randomly selected increasing the chance of CCA busy), and the exposed node (node B in FIG. 3) may sometimes defer less (when larger thresholds are randomly selected increasing the chance of CCA idle). In this way, randomizing the detection threshold may avoid that a node gets ‘stuck’ between other nodes.

New random detection thresholds may be determined at different times, for example, according to different implementations or configurations.

In some cases, a new random detection threshold may be determined at the start of each backoff. In other cases, a new random detection threshold may be determined at each subsequent backoff slot.

In some cases, a new random detection threshold may be determined at fixed time intervals. For example, the fixed time intervals may be on the order of the maximum channel occupation time.

In some cases, a new random detection threshold may be determined at each busy to idle transition occurrence. In such cases, a node may declare an “idle” slot based on the current random detection threshold.

Various parameters for randomizing detection thresholds may be determined in various ways, for example, according to different implementations or configurations. For example, the upper or lower limit of a range may be varied based on one or more considerations.

For example, the range of energy over which the detection threshold is determined, the average detection threshold, or the distribution of the detection threshold may depend on the time for which the medium has been observed busy. For example, the range may move to higher values as busy time goes by, in order to decrease the chance a node continues to declare the medium busy. This approach may also be applied for a non-random detection threshold.

In some cases, the range of energy over which the detection threshold is determined, the average detection threshold, or the distribution of the detection threshold may depend on measurements of traffic activity or the number of MAC addresses observed. For example, if only a few MAC addresses are observed, the range may be increased to allow a node to compete for access more fairly. This approach may also be applied for a non-random detection threshold.

In some cases, the range of energy over which the detection threshold is determined may depend on the priority of the traffic. In effect, the maximum transmit duty cycle at a node (such as the amount of time the node gains access to the medium relative to the time it is unable to access) may depend on the range from which the detection threshold is selected. A higher range may imply a lower duty cycle. This approach may also be applied for a non-random detection threshold.

In some cases, the range of energy may depend an intended duration to transmit or an intended duration to cause at least one transmission on the medium or both.

In some cases, the range of energy may depend on a duration of at least one previous transmission on the medium.

In some cases, the random distribution can be uniform over a given range, but it can also be any other random distribution, possibly even without a fixed range. The access priority is related to the average detection threshold in this case. A higher average detection threshold may imply a higher access priority and a lower maximum duty cycle.

The random distribution may also be selected uniformly over a given or particular physical range, which can be converted to a threshold level by applying a given channel model (in reverse) in combination with the transmit power.

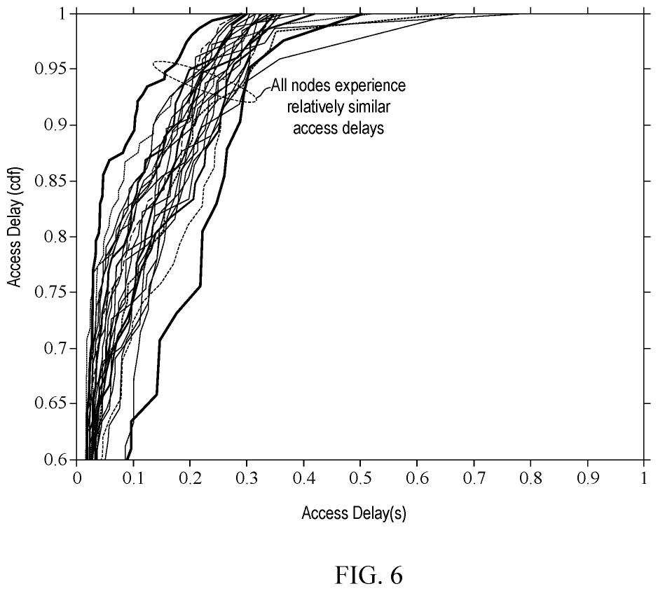

FIG. 6 illustrates how the techniques for randomizing detection thresholds presented herein may help alleviate the impact of the exposed node problem on access delay times, using the same assumptions as FIG. 4 (such as 5×5 APs, with 3 STAs per AP randomly distributed in the coverage range of each AP). As illustrated in FIG. 8, all nodes experience relatively similar access delays.

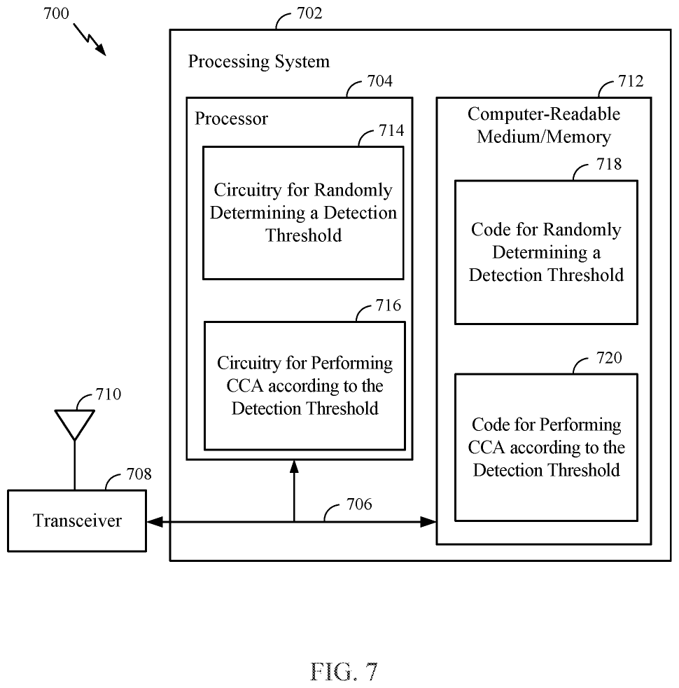

FIG. 7 illustrates an example communications device 700 such as a wireless node that may include various components configured to perform operations for the techniques disclosed herein, such as the operations illustrated in FIG. 5. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received or to be transmitted by the communications device 700. The various components of the communications device 700 can be implemented as means-plus-function components.

The processing system 702 includes a processor 704 coupled to a computer-readable medium/memory 712 via a bus 706. In certain aspects, the computer-readable medium/memory 712 is configured to store instructions (such as computer-executable code) that when executed by the processor 704, cause the processor 704 to perform the operations illustrated in FIG. 5, or other operations for performing the various techniques discussed herein. In certain aspects, computer-readable medium/memory 712 stores code 718 for randomly determining, within a range of energy, a detection threshold for assessing if a wireless medium is busy or idle and code 720 for performing CCA of the wireless medium in according to the randomly determined detection threshold. In certain aspects, the processor 704 has circuitry configured to implement the code stored in the computer-readable medium/memory 712. The processor 704 includes circuitry 714 for randomly determining, within a range of energy, a detection threshold for assessing if a wireless medium is busy or idle and circuitry 716 for performing CCA of the wireless medium in according to the randomly determined detection threshold.

In effect, randomly selecting an increased detection threshold may allow exposed nodes to access the medium more quickly. In other words, an increased detection threshold makes them less likely to declare a busy medium and back off. On the other hand, randomly selecting a decreased detection threshold makes it more likely a node will declare the medium busy and perform backoff (allowing other nodes a greater chance for access).

In some cases, the detection threshold may vary according to a duty cycle. For example, the detection threshold may vary, or be duty cycled, between two or more values. The duty cycle and the associated detection thresholds may be selected such that an average detection threshold over a given amount of time meets a certain or defined average. The defined average may be pre-defined or dynamically defined.

In some cases, the detection threshold may be continually fluctuated according to a periodic function of time. For example, the function could be a sine wave. Continually fluctuating the detection threshold implies that it changes through the course of a backoff. The detection threshold can also be fixed for the duration of the backoff based on the value of the function at the start of the backoff.

In some cases, the detection threshold may be increased when the medium has been sensed as busy for a certain or defined amount of time, which may be pre-defined or dynamically defined. The increase may be linear with time (in dBm), or stepped up after some time. The increased detection threshold will increase the probability that the channel will be idle and a transmission can occur. The time after which the increase occurs may be selected randomly.

In some cases, the detection threshold may be decreased based on one or more failed transmissions. For instance, the detection threshold may be decreased when many failed transmissions occur, such as when many negative acknowledgment (NACK) feedbacks are received. When surrounding nodes exhibit the same decrease in the detection threshold in the presence of many failed transmissions, deferral will increase and transmissions will become more sequential than parallel, increasing the likelihood of a successful transmission.

In some cases, the detection threshold may be increased in exchange for a reduced transmit duration and followed by a period of time during which no increased detection threshold is used. For example, the detection threshold is increased from a first threshold to a second threshold that is higher than the first threshold and, thereafter, a transmit duration is decreased and the detection threshold is maintained at the first threshold for a period of time.

In some cases, the detection threshold is increased from a first threshold to a second threshold that is higher than the first threshold and, thereafter, a transmit duration is decreased and the detection threshold is maintained at a third threshold, which is lower than the first threshold, for a period of time.

In addition to the various aspects described above, aspects of specific combinations are within the scope of the disclosure, some of which are detailed below:

Aspect 1: A method for wireless communications by a node, including: randomly determining, within a range of energy, a detection threshold for assessing if a medium is busy or idle; and performing clear channel assessment (CCA) of the medium according to the randomly determined detection threshold.

Aspect 2: The method of Aspect 1, where the detection threshold is selected uniformly randomly within the range.

Aspect 3: The method of any of Aspects 1-2, further including: if a result of the CCA indicates that the medium is busy, waiting for the medium to become idle before performing a backoff.

Aspect 4: The method of Aspect 3, further including performing the backoff according to a random backoff time.

Aspect 5: The method of Aspect 3, where a new detection threshold is randomly determined at least one of: at a start of a backoff slot or at each subsequent backoff slot.

Aspect 6: The method of any of Aspects 1-5, further including randomly determining new detection thresholds at fixed time intervals.

Aspect 7: The method of Aspect 6, where the fixed time intervals are determined based on a maximum channel occupation time.

Aspect 8: The method of Aspect 6, where at least one of the new random detection thresholds is randomly determined at each transition from a busy slot to an idle slot, where the idle slot is determined with respect to a current random detection threshold.

Aspect 9: The method of any of Aspects 1-8, where at least one of: the range, an average detection threshold, or a distribution of the detection threshold depends on a time for which the medium has been observed busy.

Aspect 10: The method of Aspect 9, where the range increases as a time for which the medium has been observed busy increases.

Aspect 11: The method of any of Aspects 1-10, where at least one of: the range, an average detection threshold, or a distribution of the detection threshold depends on measurements of traffic activity or a number of medium access control (MAC) addresses observed.

Aspect 12: The method of any of Aspects 1-11, where the range depends on a priority of traffic on the medium.

Aspect 13: The method of any of Aspects 1-12, where the range depends on at least one of an intended duration to transmit or an intended duration to cause at least one transmission on the medium.

Aspect 14: The method of any of Aspects 1-13, where the range depends on a duration of at least one previous transmission on the medium.

Aspect 15: The method of any of Aspects 1-14, where: a distribution of the detection threshold over the range is selected uniformly over a physical range; and the physical range is converted to a threshold level by applying a channel model in combination with a transmit power.

Aspect 16: The method of any of Aspects 1-15, where the detection threshold varies according to a duty cycle.

Aspect 17: The method of any of Aspects 1-16, where the detection threshold changes based on a periodic function of time.

Aspect 18: The method of any of Aspects 1-17, further including increasing the detection threshold if the medium has been sensed as busy for an amount of time.

Aspect 19: The method of any of Aspects 1-18, further including decreasing the detection threshold based on one or more failed transmissions.

Aspect 20: The method of any of Aspects 1-19, further including: increasing the detection threshold from a first threshold to a second threshold, where the second threshold is higher than the first threshold; thereafter, decreasing a transmit duration; and maintaining the detection threshold at the first threshold for a period of time.

Aspect 21: The method of any of Aspects 1-20, further including: increasing the detection threshold from a first threshold to a second threshold, where the second threshold is higher than the first threshold; and thereafter, decreasing a transmit duration; and maintaining the detection threshold at a third threshold for a period of time, where the third threshold is lower than the first threshold.

Aspect 22: An apparatus for wireless communications by a node, including: means for randomly determining, within a range of energy, a detection threshold for assessing if a medium is busy or idle; and means for performing clear channel assessment (CCA) of the medium according to the randomly determined detection threshold.

Aspect 23: The apparatus of Aspect 22, where the detection threshold is selected uniformly randomly within the range.

Aspect 24: The apparatus of any of Aspects 22-23, further including: if a result of the CCA indicates that the medium is busy, means for waiting for the medium to become idle before performing a backoff.

Aspect 25: The apparatus of Aspect 24, further including means for performing the backoff according to a random backoff time.

Aspect 26: The apparatus of Aspect 24, where a new detection threshold is randomly determined at least one of: at a start of a backoff slot or at each subsequent backoff slot.

Aspect 27: The apparatus of any of Aspects 22-26, further including means for randomly determining new detection thresholds at fixed time intervals.

Aspect 28: The apparatus of Aspect 27, where the fixed time intervals are determined based on a maximum channel occupation time.

Aspect 29: The apparatus of Aspect 27, where at least one of the new random detection thresholds is randomly determined at each transition from a busy slot to an idle slot, where the idle slot is determined with respect to a current random detection threshold.

Aspect 30: The apparatus of any of Aspects 22-29, where at least one of: the range, an average detection threshold, or a distribution of the detection threshold depends on a time for which the medium has been observed busy.

Aspect 31: The apparatus of Aspect 30, where the range increases as a time for which the medium has been observed busy increases.

Aspect 32: The apparatus of any of Aspects 22-31, where at least one of: the range, an average detection threshold, or a distribution of the detection threshold depends on measurements of traffic activity or a number of medium access control (MAC) addresses observed.

Aspect 33: The apparatus of any of Aspects 22-32, where the range depends on a priority of traffic on the medium.

Aspect 34: The apparatus of any of Aspects 22-33, where the range depends on at least one of an intended duration to transmit or an intended duration to cause at least one transmission on the medium.

Aspect 35: The apparatus of any of Aspects 22-34, where the range depends on a duration of at least one previous transmission on the medium.

Aspect 36: The apparatus of any of Aspects 22-35, where: a distribution of the detection threshold over the range is selected uniformly over a physical range; and the physical range is converted to a threshold level by applying a channel model in combination with a transmit power.

Aspect 37: The apparatus of any of Aspects 22-36, where the detection threshold varies according to a duty cycle.

Aspect 38: The apparatus of any of Aspects 22-37, where the detection threshold changes based on a periodic function of time.

Aspect 39: The apparatus of any of Aspects 22-38, further including means for increasing the detection threshold if the medium has been sensed as busy for an amount of time.

Aspect 40: The apparatus of any of Aspects 22-39, further including means for decreasing the detection threshold based on one or more failed transmissions.

Aspect 41: The apparatus of any of Aspects 22-40, further including: means for increasing the detection threshold from a first threshold to a second threshold, where the second threshold is higher than the first threshold; thereafter, means for decreasing a transmit duration; and means for maintaining the detection threshold at the first threshold for a period of time.

Aspect 42: The apparatus of any of Aspects 22-41, further including: means for increasing the detection threshold from a first threshold to a second threshold, where the second threshold is higher than the first threshold; and thereafter, means for decreasing a transmit duration; and means for maintaining the detection threshold at a third threshold for a period of time, where the third threshold is lower than the first threshold.

Aspect 43: An apparatus for wireless communications by a node, including a processing system configured to: randomly determine, within a range of energy, a detection threshold for assessing if a medium is busy or idle; and perform clear channel assessment (CCA) of the medium according to the randomly determined detection threshold.

Aspect 44: The apparatus of Aspect 43, where the detection threshold is selected uniformly randomly within the range.

Aspect 45: The apparatus of any of Aspects 43-44, where the processing system is further configured to: if a result of the CCA indicates that the medium is busy, wait for the medium to become idle before performing a backoff.

Aspect 46: The apparatus of Aspect 45, where the processing system is further configured to perform the backoff according to a random backoff time.

Aspect 47: The apparatus of Aspect 45, where a new detection threshold is randomly determined at least one of: at a start of a backoff slot or at each subsequent backoff slot.

Aspect 48: The apparatus of any of Aspects 43-47, where the processing system is further configured to randomly determining new detection thresholds at fixed time intervals.

Aspect 49: The apparatus of Aspect 48, where the fixed time intervals are determined based on a maximum channel occupation time.

Aspect 50: The apparatus of Aspect 48, where at least one of the new random detection thresholds is randomly determined at each transition from a busy slot to an idle slot, where the idle slot is determined with respect to a current random detection threshold.

Aspect 51: The apparatus of any of Aspects 43-50, where at least one of: the range, an average detection threshold, or a distribution of the detection threshold depends on a time for which the medium has been observed busy.

Aspect 52: The apparatus of Aspect 51, where the range increases as a time for which the medium has been observed busy increases.

Aspect 53: The apparatus of any of Aspects 43-52, where at least one of: the range, an average detection threshold, or a distribution of the detection threshold depends on measurements of traffic activity or a number of medium access control (MAC) addresses observed.

Aspect 54: The apparatus of any of Aspects 43-53, where the range depends on a priority of traffic on the medium.

Aspect 55: The apparatus of any of Aspects 43-54, where the range depends on at least one of an intended duration to transmit or an intended duration to cause at least one transmission on the medium.

Aspect 56: The apparatus of any of Aspects 43-55, where the range depends on a duration of at least one previous transmission on the medium.

Aspect 57: The apparatus of any of Aspects 43-56, where: a distribution of the detection threshold over the range is selected uniformly over a physical range; and the physical range is converted to a threshold level by applying a channel model in combination with a transmit power.

Aspect 58: The apparatus of any of Aspects 43-57, where the detection threshold varies according to a duty cycle.

Aspect 59: The apparatus of any of Aspects 43-58, where the detection threshold changes based on a periodic function of time.

Aspect 60: The apparatus of any of Aspects 43-59, where the processing system is further configured to increase the detection threshold if the medium has been sensed as busy for an amount of time.

Aspect 61: The apparatus of any of Aspects 43-60, where the processing system is further configured to decrease the detection threshold based on one or more failed transmissions.

Aspect 62: The apparatus of any of Aspects 43-61, where the processing system is further configure to: increase the detection threshold from a first threshold to a second threshold, where the second threshold is higher than the first threshold; thereafter, decrease a transmit duration; and maintain the detection threshold at the first threshold for a period of time.

Aspect 63: The apparatus of any of Aspects 43-62, where the processing system is further configure to: increase the detection threshold from a first threshold to a second threshold, where the second threshold is higher than the first threshold; and thereafter, decrease a transmit duration; and maintain the detection threshold at a third threshold for a period of time, where the third threshold is lower than the first threshold.

Aspect 64: A wireless node, including: at least one antenna; and a processing system configured to: randomly determine, within a range of energy, a detection threshold for assessing if a medium is busy or idle; and perform, via the at least one antenna, clear channel assessment (CCA) of the medium according to the randomly determined detection threshold.

Aspect 65: A computer-readable medium for wireless communications including codes executable to: randomly determine, within a range of energy, a detection threshold for assessing if a medium is busy or idle; and perform, via the at least one antenna, clear channel assessment (CCA) of the medium according to the randomly determined detection threshold.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, processors 260m, 270m, 288m and 290m of the UT 120m and/or processors 210, 220, 240, and 242 of the AP 110 shown in FIG. 2 may be configured to perform operations 500 of FIG. 5.

Means for receiving may include a receiver (such as one or more antennas or receive processors) illustrated in FIG. 2. Means for randomly determining, means for performing, means for increasing, means for decreasing, means for maintaining and means for waiting may include a processing system, which may include one or more processors, such as processors 260m, 270m, 288m and 290m of the UT 120m and/or processors 210, 220, 240, and 242 of the AP 110 shown in FIG. 2. In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

As used herein, the term “determining” encompasses a wide variety of actions. For example, “determining” may include calculating, computing, processing, deriving, investigating, looking up (such as looking up in a table, a database or another data structure), ascertaining and the like. Also, “determining” may include receiving (such as receiving information), accessing (such as accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communications by a node, comprising:
randomly determining, within a range of energy, a detection threshold for assessing if a wireless medium is busy or idle; and
performing clear channel assessment (CCA) of the wireless medium according to the randomly determined detection threshold.

2. The method of claim 1, wherein the detection threshold is selected uniformly randomly within the range of energy.

3. The method of claim 1, further comprising:
if a result of the CCA indicates that the wireless medium is busy, waiting for the wireless medium to become idle before performing a backoff.

4. The method of claim 3, further comprising performing the backoff according to a random backoff time.

5. The method of claim 3, wherein a new detection threshold is randomly determined at least one of: at a start of a backoff slot or at each subsequent backoff slot.

6. The method of claim 1, further comprising:
randomly determining new detection thresholds at fixed time intervals.

7. The method of claim 6, wherein the fixed time intervals are determined based on a maximum channel occupation time.

8. The method of claim 6, wherein at least one of the new random detection thresholds is randomly determined at each transition from a busy slot to an idle slot, wherein the idle slot is determined with respect to a current random detection threshold.

9. The method of claim 1, wherein at least one of: the range of energy, an average detection threshold, or a distribution of the detection threshold depends on a time for which the wireless medium has been observed busy.

10. The method of claim 9, wherein the range of energy increases as a time for which the wireless medium has been observed busy increases.

11. The method of claim 1, wherein at least one of: the range of energy, an average detection threshold, or a distribution of the detection threshold depends on measurements of traffic activity or a number of medium access control (MAC) addresses observed.

12. The method of claim 1, wherein the range of energy depends on a priority of traffic on the wireless medium.

13. The method of claim 1, wherein the range of energy depends on at least one of an intended duration to transmit or an intended duration to cause at least one transmission on the wireless medium.

14. The method of claim 1, wherein the range of energy depends on a duration of at least one previous transmission on the wireless medium.

15. The method of claim 1, wherein:
a distribution of the detection threshold over the range of energy is selected uniformly over a physical range; and
the physical range is converted to a threshold level by applying a channel model in combination with a transmit power.

16. The method of claim 1, wherein the detection threshold varies according to a duty cycle.

17. The method of claim 1, wherein the detection threshold changes based on a periodic function of time.

18. The method of claim 1, further comprising increasing the detection threshold if the wireless medium has been sensed as busy for an amount of time.

19. The method of claim 1, further comprising decreasing the detection threshold based on one or more failed transmissions.

20. The method of claim 1, further comprising:
increasing the detection threshold from a first threshold to a second threshold, wherein the second threshold is higher than the first threshold;
thereafter, decreasing a transmit duration; and
maintaining the detection threshold at the first threshold for a period of time.

21. The method of claim 1, further comprising:
increasing the detection threshold from a first threshold to a second threshold, wherein the second threshold is higher than the first threshold; and
thereafter, decreasing a transmit duration; and
maintaining the detection threshold at a third threshold for a period of time, wherein the third threshold is lower than the first threshold.

22. An apparatus for wireless communications by a node, comprising:
a processing system configured to:
randomly determine, within a range of energy, a detection threshold for assessing if a wireless medium is busy or idle; and
perform clear channel assessment (CCA) of the wireless medium according to the randomly determined detection threshold.

23. The apparatus of claim 22, wherein at least one of: the range of energy, an average detection threshold, or a distribution of the detection threshold depends on a time for which the wireless medium has been observed busy.

24. The apparatus of claim 22, wherein the range of energy depends on a priority of traffic on the wireless medium or wherein the range of energy depends on at least one of an intended duration to transmit or an intended duration to cause at least one transmission on the wireless medium.

25. The apparatus of claim 22, wherein the detection threshold varies according to a duty cycle or wherein the detection threshold changes based on a periodic function of time.

26. The apparatus of claim 22, wherein the processing system is further configured to increase the detection threshold if the wireless medium has been sensed as busy for an amount of time.

27. A wireless node, comprising:
at least one antenna; and
a processing system configured to:
randomly determine, within a range of energy, a detection threshold for assessing if a wireless medium is busy or idle; and
perform, via the at least one antenna, clear channel assessment (CCA) of the wireless medium according to the randomly determined detection threshold.

28. The wireless node of claim 27, wherein at least one of: the range of energy, an average detection threshold, or a distribution of the detection threshold depends on a time for which the wireless medium has been observed busy.

29. The wireless node of claim 27, wherein the range of energy depends on a priority of traffic on the wireless medium or wherein the range of energy depends on at least one of an intended duration to transmit or an intended duration to cause at least one transmission on the wireless medium.

30. The wireless node of claim 27, wherein the processing system is further configured to increase the detection threshold if the wireless medium has been sensed as busy for an amount of time.
